(19) United States
(12) Patent Application Publication
(10) Pub. No.: US 2024/0266498 A1
(43) Pub. Date: Aug. 8, 2024

(54) ALL-SOLID-STATE BATTERY

(71) Applicant: HONDA MOTOR CO., LTD., Tokyo (JP)

(72) Inventors: Kiyoshi Tanaami, Wako-shi (JP); Toshimitsu Tanaka, Wako-shi (JP)

(21) Appl. No.: 18/429,697

(22) Filed: Feb. 1, 2024

(30) Foreign Application Priority Data
Feb. 3, 2023 (JP) 2023-015240

(51) Int. Cl. H01M 4/13; H01M 4/80; H01M 10/0525; H01M 10/0565

(52) U.S. Cl. CPC H01M 4/13; H01M 4/80; H01M 10/0525; H01M 10/0565; H01M 2300/0082; H01M 2300/0094

(57) ABSTRACT

An all-solid-state battery 1 including: an all-solid-state battery positive electrode in which a positive electrode active material layer is formed on a positive electrode current collector; an all-solid-state battery negative electrode in which a negative electrode active material layer is formed on a negative electrode current collector; and a solid electrolyte layer disposed between the all-solid-state battery positive electrode and the all-solid-state battery negative electrode, wherein at least one of the positive electrode active material layer and the negative electrode active material layer is a porous active material layer including a porous current collector and an active material filled in the current collector, an intermediate layer is disposed between the porous active material layer and the solid electrolyte layer, and the intermediate layer includes at least one selected from a gel, a polymer, and a high viscosity electrolyte.

### BACKGROUND OF THE INVENTION

### Field of the Invention

The present invention relates to an all-solid-state battery.

### Description of the Related Art

An all-solid-state battery is provided with a positive electrode, a negative electrode, and a solid electrolyte layer disposed between the positive electrode and the negative electrode. In the all-solid-state battery, the positive electrode and the negative electrode are present while sandwiching the solid electrolyte layer formed by compacting fine particles of solid electrolyte powder therebetween (for example, see Patent Document 1).

### PRIOR ART DOCUMENTS

### Patent Document

[Patent Document 1] Japanese Unexamined Patent Application, First Publication No. 2020-173954

### SUMMARY OF THE INVENTION

### Problems to Be Solved by the Invention

Since solids are brought into contact with each other at the interface between the positive electrode and the solid electrolyte layer and the interface between the negative electrode and the solid electrolyte layer, in order to form favorable interfaces, that is, in order to increase contact areas of the positive electrode and the negative electrode with the solid electrolyte layer, it is necessary to apply high confining pressure to a laminate composed of the positive electrode, the negative electrode and the solid electrolyte layer. However, due to the expansion and contraction of the electrode during charging and discharging, a load is applied to the electrode and the solid electrolyte layer, thereby causing cracks and the like, making the above interface unstable and promoting deterioration of the electrode and the solid electrolyte layer.

Accordingly, in order to stabilize the above-mentioned interface, introduction of a flexible semi-solid electrolyte into the above-mentioned interface has been considered. However, since the semi-solid electrolyte is flexible, it may be released to the outside of the laminate composed of the positive electrode, the negative electrode and the solid electrolyte layer. In that case, the above-mentioned interface becomes unstable and the cycle characteristics of the all-solid-state battery deteriorate, which are problematic.

In order to solve the above problems, the present application has an object of making at least one of the interface between the positive electrode and the solid electrolyte layer and the interface between the negative electrode and the solid electrolyte layer into a stable interface, thereby suppressing the deterioration of the cycle characteristics of the all-solid-state battery. Further, this in turn contributes to energy efficiency.

### Means for Solving the Problem

In order to achieve the above object, the present invention provides the following means.

[1] An all-solid-state battery including: an all-solid-state battery positive electrode in which a positive electrode active material layer is formed on a positive electrode current collector;
an all-solid-state battery negative electrode in which a negative electrode active material layer is formed on a negative electrode current collector; and
a solid electrolyte layer disposed between the aforementioned all-solid-state battery positive electrode and the aforementioned all-solid-state battery negative electrode, wherein
at least one of the aforementioned positive electrode active material layer and the aforementioned negative electrode active material layer is a porous active material layer including a porous current collector and an active material filled in the aforementioned current collector,
an intermediate layer is disposed between the aforementioned porous active material layer and the aforementioned solid electrolyte layer, and
the aforementioned intermediate layer includes at least one selected from a gel, a polymer, and a high viscosity electrolyte.

In the all-solid battery of the present invention, at least one of the positive electrode active material layer and the negative electrode active material layer is a porous active material layer including a porous current collector and an active material filled in the current collector, an intermediate layer is disposed between the porous active material layer and the solid electrolyte layer, and the intermediate layer includes at least one selected from a gel, a polymer, and a high viscosity electrolyte, so that it is possible to make at least one of the interface between the all-solid-state battery positive electrode and the solid electrolyte layer and the interface between the all-solid-state battery negative electrode and the solid electrolyte layer into a stable interface, and to suppress the deterioration of the cycle characteristics of the all-solid-state battery.

[2] The all-solid-state battery according to [1], wherein the aforementioned porous active material layer has a void on the aforementioned solid electrolyte layer side, and the aforementioned intermediate layer is disposed in the aforementioned void.

Since the porous active material layer has a void on the solid electrolyte layer side, and the intermediate layer is disposed in the void, it is possible to make at least one of the interface between the all-solid-state battery positive electrode and the solid electrolyte layer and the interface between the all-solid-state battery negative electrode and the solid electrolyte layer into a stable interface.

[3] The all-solid-state battery according to [1], wherein the aforementioned negative electrode active material layer contains metallic lithium, a lithium alloy, or silicon.

Even if the negative electrode active material layer contains metallic lithium, a lithium alloy, or silicon, it is possible to make at least one of the interface between the all-solid-state battery positive electrode and the solid electrolyte layer and the interface between the all-solid-state battery negative electrode and the solid electrolyte layer into a stable interface.

### Effects of the Invention

According to the present invention, it is possible to make at least one of the interface between the positive electrode and the solid electrolyte layer and the interface between the negative electrode and the solid electrolyte layer into a stable interface, and to suppress the deterioration of the cycle characteristics of the all-solid-state battery.

### BRIEF DESCRIPTION OF THE DRAWINGS

FIG. 1 is a cross-sectional view showing an example of an all-solid-state battery according to an embodiment of the present invention.

FIG. 2 is a cross-sectional view showing an example of an all-solid-state battery according to an embodiment of the present invention.

FIG. 3 is a schematic diagram showing a method for producing a positive electrode constituting an all-solid-state battery according to an embodiment of the present invention.

FIG. 4 is a perspective view showing a method for producing a positive electrode constituting an all-solid-state battery according to an embodiment of the present invention.

FIG. 5 is a perspective view showing a method for producing a positive electrode constituting an all-solid-state battery according to an embodiment of the present invention.

### DETAILED DESCRIPTION OF THE INVENTION

Hereinafter, embodiments of the present invention will be described in detail.

### All-Solid-State Battery

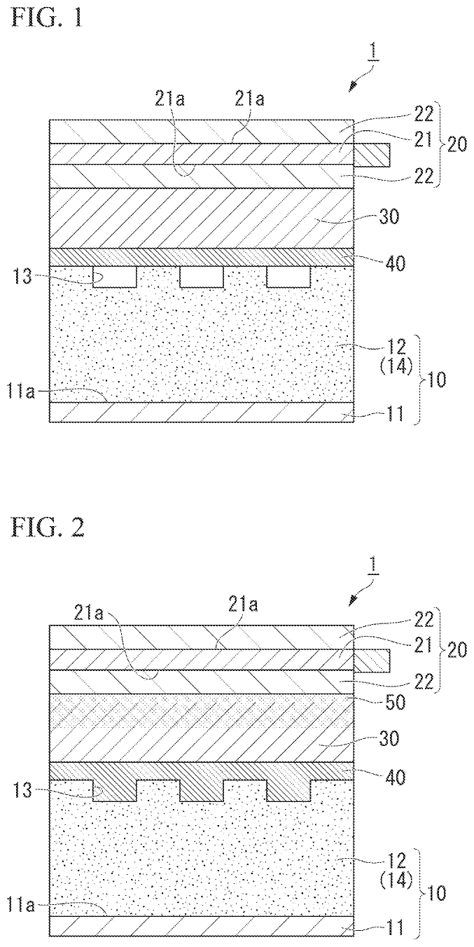

FIG. 1 is a cross-sectional view showing an example of an all-solid-state battery according to an embodiment of the present invention. It should be noted that in the drawings used in the following description, characteristic portions may be shown conveniently in an enlarged manner in some cases in order to facilitate understanding of the characteristics thereof, and the dimensional ratios or the like of each constituent are not limited to those shown in the drawings.

An all-solid-state battery 1 includes an all-solid-state battery positive electrode (hereinafter sometimes abbreviated as a “positive electrode”) 10, an all-solid-state battery negative electrode (hereinafter sometimes abbreviated as a “negative electrode”) 20, a solid electrolyte layer 30 and an intermediate layer 40. In the all-solid-state battery 1, the positive electrode 10 and the negative electrode 20 are laminated via the solid electrolyte layer 30 and the intermediate layer 40.

The positive electrode 10 includes a positive electrode current collector 11 and a positive electrode active material layer 12 formed on one main surface 11a of the positive electrode current collector 11.

The positive electrode active material layer 12 is a porous active material layer that includes a porous current collector 14 and a positive electrode active material filled in the current collector 14.

It is preferable that the positive electrode active material layer 12 has voids 13 on the solid electrolyte layer 30 side. The voids 13 are, for example, a portion where the amount of a positive electrode mixture 60 filled is small or a portion where the positive electrode mixture 60 is not filled in the current collector 14.

The negative electrode 20 includes a negative electrode current collector 21 and negative electrode active material layers 22 formed on both main surfaces 21a of the negative electrode current collector 21.

The intermediate layer 40 is disposed between the positive electrode active material layer 12 and the solid electrolyte layer 30.

### Positive Electrode

The positive electrode current collector 11 is preferably constituted of at least one substance having high electrical conductivity.

Examples of the substance having high electrical conductivity include metals or alloys containing at least any one metal element among silver (Ag), palladium (Pd), gold (Au), platinum (Pt), aluminum (Al), copper (Cu), chromium (Cr), and nickel (Ni), and nonmetals such as carbon (C). When considering the production cost in addition to the high electrical conductivity, aluminum, nickel, or stainless steel is preferred. Furthermore, aluminum hardly reacts with a positive electrode active material, a negative electrode active material, and a solid electrolyte. Therefore, when aluminum is used for the positive electrode current collector 11, the internal resistance of the all-solid-state battery 1 can be reduced.

Examples of the form of the positive electrode current collector 11 include a foil form, a plate form, a mesh form, a nonwoven fabric form, and a foam form. Further, in order to enhance adhesion to the positive electrode active material layer 12, carbon or the like may be disposed on the surface of the positive electrode current collector 11, or the surface may be roughened.

The positive electrode active material layer 12 includes the porous current collector 14 and a positive electrode active material that is filled in the current collector 14 and allows transfer of lithium ions and electrons thereto and therefrom.

The porous current collector 14 is not particularly limited as long as it can be filled with a positive electrode active material, and examples thereof include a porous body composed of fibrous carbon, a porous body composed of porous carbon, a porous body composed of a transition metal, and a metallic body having a honeycomb structure.

The positive electrode active material is not particularly limited as long as it is a material that can reversibly release and occlude lithium ions and can transport electrons, and any known positive electrode active material applicable to a positive electrode of an all-solid-state lithium ion battery can be used. Examples thereof include complex oxides such as lithium cobalt oxide (LiCoO₂), lithium nickel oxide (LiNiO₂), lithium manganese oxide (LiMn₂O₄), solid solution oxides (Li₂MnO₃—LiMO₂ (M=Co, Ni, or the like)), lithium-manganese-nickel-cobalt oxides (LiNiₓMn_{y}Co_{z}O₂, x+y+z=1) and olivine-type lithium phosphorus oxide (LiFePO₄); conductive polymers such as polyaniline and polypyrrole; sulfides such as Li₂S, CuS, Li—Cu—S compounds, TiS₂ , FeS, MoS₂ and Li—Mo—S compounds; and mixtures of sulfur and carbon. The positive electrode active material may be formed of one of the above-described materials alone, or may be formed of two or more types thereof.

The positive electrode active material layer 12 may contain a conductive auxiliary agent from the viewpoint of improving the electrical conductivity of the positive electrode 10. As the conductive auxiliary agent, a conductive auxiliary agent that can generally be used for all-solid-state lithium ion batteries can be used. Examples thereof include carbon black such as acetylene black and Ketjen black; carbon fibers; vapor grown carbon fibers; graphite powder; and carbon materials such as carbon nanotubes. The conductive auxiliary agent may be formed of one of the above-described materials alone, or may be formed of two or more types thereof.

Further, the positive electrode active material layer 12 maycontain a binder having a role of binding the positive electrode active materials to each other and binding the positive electrode active material and the positive electrode current collector 11.

In the present embodiment, the positive electrode active material layer 12 is formed on one main surface 11a of the positive electrode current collector 11, but the present invention is not limited thereto, and the positive electrode active material layer 12 maybe formed on both main surfaces of the positive electrode current collector 11. Further, when the positive electrode active material layer 12 has a three-dimensional porous structure such as a mesh form, a nonwoven fabric form, or a foam form, the positive electrode active material layer 12 maybe provided integrally with the positive electrode current collector 11.

The positive electrode 10 maybe provided with a micron-sized metal pillar formed on the positive electrode current collector 11 and the positive electrode active material layer 12 formed so as to include the metal pillar.

### Negative Electrode

Like the positive electrode current collector 11, the negative electrode current collector 21 is preferably constituted of at least one substance having high electrical conductivity. Examples of the substance having high electrical conductivity include metals or alloys containing at least any one metal element among silver (Ag), palladium (Pd), gold (Au), platinum (Pt), aluminum (Al), copper (Cu), chromium (Cr), and nickel (Ni), and nonmetals such as carbon (C). When considering the production cost in addition to the high electrical conductivity, copper, nickel, or stainless steel is preferred. Furthermore, stainless steel hardly reacts with a positive electrode active material, a negative electrode active material, and a solid electrolyte. Therefore, when stainless steel is used for the negative electrode current collector 21, the internal resistance of the all-solid-state battery can be reduced.

Examples of the form of the negative electrode current collector 21 include a foil form, a plate form, a mesh form, a nonwoven fabric form, and a foam form. Further, in order to enhance adhesion to the negative electrode active material layer 22, carbon or the like may be disposed on the surface of the negative electrode current collector 21, or the surface may be roughened.

The negative electrode active material layer 22 includes a negative electrode active material that is filled in the current collector 22 and allows transfer of lithium ions and electrons thereto and therefrom. The negative electrode active material is not particularly limited as long as it is a material that can reversibly release and occlude lithium ions and can transport electrons, and any known negative electrode active material applicable to a negative electrode of an all-solid-state lithium ion battery can be used. Examples thereof include carbonaceous materials such as natural graphite, artificial graphite, resinous coal, carbon fibers, activated carbon, hard carbon, and soft carbon; alloy-based materials mainly composed of tin, tin alloys, silicon, silicon alloys, gallium, gallium alloys, indium, indium alloys, aluminum, aluminum alloys, and the like; conductive polymers such as polyacene, polyacetylene, and polypyrrole; metallic lithium, and lithium alloys; and lithium-titanium composite oxides (for example, Li₄Ti₅O₁₂). These negative electrode active materials may be formed of one of the above-described materials alone, or may be formed of two or more types thereof.

The negative electrode active material layer 22 maycontain a conductive auxiliary agent, a binder, and the like. Although these materials are not particularly limited, for example, the same materials as those used for the positive electrode active material layer 12 described above can be used.

### Solid Electrolyte Layer

The solid electrolyte layer 30 is disposed between the positive electrode active material layer 12 and the negative electrode active material layer 22.

The solid electrolyte described above is not particularly limited as long as it has lithium ion conductivity and insulating properties, and materials generally used for all-solid-state lithium ion batteries can be used. Examples thereof include inorganic solid electrolytes such as a sulfide solid electrolyte material, an oxide solid electrolyte material, a halide solid electrolyte, and a lithium-containing salt, polymer-based solid electrolytes such as polyethylene oxide, and gel-based solid electrolytes containing a lithium-containing salt or lithium ion conductive ionic liquid. Among these, sulfide solid electrolyte materials are preferred from the viewpoints of high conductivity of lithium ions, and favorable structural formability and interfacial bonding properties by pressing.

Although the form of the solid electrolyte material is not particularly limited, examples thereof include a particulate form.

The solid electrolyte layer 30 maycontain a pressure-sensitive adhesive for imparting mechanical strength and flexibility.

The solid electrolyte layer 30 maybe in a sheet form having a porous base material and a solid electrolyte held by this porous base material. Although the form of the porous base material described above is not particularly limited, examples thereof include a woven fabric, a nonwoven fabric, a mesh cloth, a porous membrane, an expanded sheet, and a punched sheet. Among these forms, a nonwoven fabric is preferred from the viewpoint of handling properties that allow the amount of the solid electrolyte filled to be further increased.

It is preferable that the porous base material described above is formed of an insulating material. As a result, the insulating properties of the solid electrolyte layer 30 can be improved. Examples of the insulating material include resin materials such as nylon, polyester, polyethylene, polypropylene, polytetrafluoroethylene, ethylene-tetrafluoroethylene copolymers, polyvinylidene fluoride, polyvinylidene chloride, polyvinyl chloride, polyurethane, vinylon, polybenzimidazole, polyimide, polyphenylene sulfite, polyether ether ketone, cellulose, and acrylic resins; natural fibers such as hemp, wood pulp, and cotton linters; and glass.

### Intermediate Layer

The intermediate layer 40 includes at least one selected from a gel, a polymer, and a high viscosity electrolyte.

Examples of the gel include a gel electrolyte containing a gelling material that utilizes a π-π stacking interaction and has a perfluoroalkyl group and a phenylene group, and an electrolytic solution. Examples of the electrolytic solution contained in the gel electrolyte include an electrolytic solution containing dimethyl carbonate and lithium bis(fluorosulfonyl)imide, and having a molar ratio of dimethyl carbonate with respect to lithium bis(fluorosulfonyl)imide of 1.1 or more and 3.0 or less.

As described above, according to the all-solid-state battery 1 of the present embodiment, since the positive electrode active material layer 12 is a porous active material layer that includes a porous current collector and a positive electrode active material filled in the current collector, and the intermediate layer 40 containing at least one selected from a gel, a polymer, and a high viscosity electrolyte is disposed between the positive electrode active material layer 12 and the solid electrolyte layer 30, it is possible to make the interface between the positive electrode 10 and the solid electrolyte layer 30 into a stable interface and to suppress the deterioration of the cycle characteristics of the all-solid-state battery.

In addition, as shown in FIG. 2, in the all-solid-state battery 1 of the present embodiment, since the positive electrode active material layer 12 has the voids 13 on the solid electrolyte layer 30 side, lithium ions 50 deposited from the negative electrode 20 permeate through the solid electrolyte layer 30 by repeated charging and discharging, as a result of which the intermediate layer 40 is pushed by the lithium ions 50 and the intermediate layer 40 is filled into the voids 13. Therefore, the interface between the positive electrode 10 and the solid electrolyte layer 30 can be made a stable interface, and deterioration of the cycle characteristics of the all-solid-state battery can be suppressed.

It should be noted that in the all-solid-state battery of the present embodiment, the negative electrode active material layer 22 of the negative electrode 20 maybe a porous active material layer including a porous current collector and a negative electrode active material filled in the current collector. When the negative electrode active material layer 22 is a porous active material layer, the intermediate layer 40 is disposed between the negative electrode active material layer 22 and the solid electrolyte layer 30. Further, in the all-solid-state battery of the present embodiment, the positive electrode active material layer 12 and the negative electrode active material layer 22 maybe porous active material layers. When the positive electrode active material layer 12 and the negative electrode active material layer 22 are porous active material layers, the intermediate layer 40 is disposed between the positive electrode active material layer 12 and the solid electrolyte layer 30 and between the negative electrode active material layer 22 and the solid electrolyte layer 30.

### Method for Producing Positive Electrode

A method for forming the voids 13 in the positive electrode active material layer 12 in the positive electrode 10 will be described.

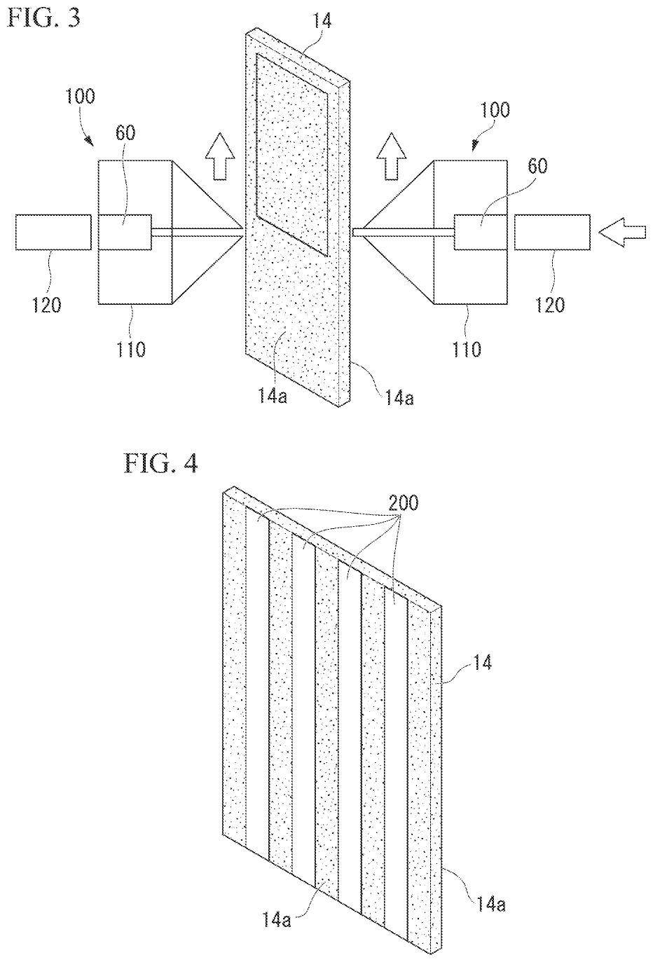

As shown in FIG. 3, the positive electrode mixture 60 containing a positive electrode active material is filled into the porous current collector 14 using a coating apparatus 100 to form the positive electrode active material layer 12. The coating apparatus 100 includes a coater 110 and a plunger 120.

While moving the coater 110 along both main surfaces 14a of the current collector 14, the positive electrode mixture 60 is filled into an arbitrary position of the current collector 14. At this time, by pushing out the positive electrode mixture 60 in the coater 110 with the plunger 120, the current collector 14 is filled with the positive electrode mixture 60.

The voids 13 are formed in the positive electrode active material layer 12 by adjusting the position at which the positive electrode mixture 60 is filled in the current collector 14 and the amount of the positive electrode mixture 60 filled in the current collector 14. That is, in the current collector 14, a portion where the amount of the positive electrode mixture 60 filled is small or a portion where the positive electrode mixture 60 is not filled becomes the void 13.

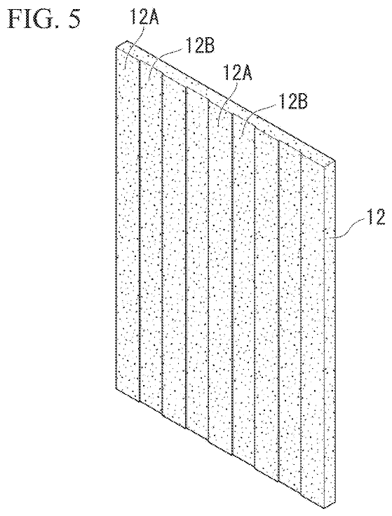

Further, as shown in FIG. 4, with masking 200 provided on both main surfaces 14a of the current collector 14 at arbitrary intervals, a portion in the current collector 14 where the masking 200 is not provided is filled with the positive electrode mixture 60 using the coating apparatus 100 as described above. Thereafter, as shown in FIG. 5, by peeling off the masking 200, the positive electrode active material layer 12 in which regions 12A filled with the positive electrode mixture 60 and regions 12B not filled with the positive electrode mixture 60 are alternately provided is obtained. The region 12B that is not filled with the positive electrode mixture 60 becomes the void 13.

While preferred embodiments of the present invention have been described and illustrated above in detail, the present invention is not limited to the above embodiments, and various modifications and changes can be made within the scope of the present invention described in the claims.

### DESCRIPTION OF THE REFERENCE SYMBOLS

1: All-solid-state battery
10: All-solid-state battery positive electrode (positive electrode)
11: Positive electrode current collector
12: Positive electrode active material layer
13: Void
20: All-solid-state battery negative electrode (negative electrode)
21: Negative electrode current collector
22: Negative electrode active material layer
30: Solid electrolyte layer
40: Intermediate layer
50: Lithium ion

What is claimed is:

1. An all-solid-state battery comprising:
an all-solid-state battery positive electrode in which a positive electrode active material layer is formed on a positive electrode current collector;
an all-solid-state battery negative electrode in which a negative electrode active material layer is formed on a negative electrode current collector; and
a solid electrolyte layer disposed between said all-solid-state battery positive electrode and said all-solid-state battery negative electrode,
wherein at least one of said positive electrode active material layer and said negative electrode active material layer is a porous active material layer including a porous current collector and an active material filled in said current collector,
an intermediate layer is disposed between said porous active material layer and said solid electrolyte layer, and
said intermediate layer includes at least one selected from a gel, a polymer, and a high viscosity electrolyte.

2. The all-solid-state battery according to claim 1, wherein said porous active material layer comprises a void on said solid electrolyte layer side, and said intermediate layer is disposed in said void.

3. The all-solid-state battery according to claim 1, wherein said negative electrode active material layer comprises metallic lithium, a lithium alloy, or silicon.
